(19) United States
(12) Patent Application Publication
(10) Pub. No.: US 2021/0182918 A1
(43) Pub. Date: Jun. 17, 2021

(54) GENERATING 360 DEGREE INTERACTIVE CONTENT

(71) Applicant: Social Nation, Inc., Millbrae, CA (US)

(72) Inventors: Vibhavee Trairattanapa, Bangkok (TH); Pairote Leelaphattarakij, Bangkok (TH); Sittiphol Phanvilai, Millbrae, CA (US); Jatupon Sukkasem, Bangkok (TH); Chulayuth Asawaroengchai, Bangkok (TH); Sarin Achawaranont, Bangkok (TH); Phoomparin Mano, Bangkok (TH); Ekasit Awatchanakanwong, Bangkok (TH); Nawaporn Upariboon, Bangkok (TH); Prachaya Phaisanwiphatpong, Millbrae, CA (US); Michael Rucker, Redwood City, CA (US)

(21) Appl. No.: 16/714,354

(22) Filed: Dec. 13, 2019

(51) Int. Cl. G06Q 30/02; G06T 15/00

(52) U.S. Cl. CPC G06Q 30/0276; G06T 15/00; G06Q 30/0269

(57) ABSTRACT

Systems and methods for distributing a three dimensional (3D) online advertisement are described. The systems and methods may provide for receiving an uploaded 3D image file, the 3D image file comprising a panoramic photo or panoramic video, converting the 3D image file to a first format configured to be accepted by a first digital advertising platform, generating a display advertisement including the 3D image file, displaying the display advertisement on a device through the first digital advertising platform.

### BACKGROUND

The following relates generally to the creation and distribution of 3D images.

Advertisers often use 2D images to create online advertising banners. This is because 2D technology is provided out-of-the-box by web browsers and does not require a special system to design and implement the ads. However, ad banners created using 2D images may not be as effective as 3D or 360 degree images at drawing attention. Therefore, it would be desirable for advertisers and other producers and consumers of images to efficiently generate and deploy 3D and 360 degree advertisements campaigns.

### BRIEF SUMMARY

A computer-implemented method, apparatus, and non-transitory computer readable medium for distributing a three dimensional (3D) online advertisement. The computer-implemented method, apparatus, and non-transitory computer readable medium may provide for receiving an uploaded 3D image file, the 3D image file comprising a panoramic photo or panoramic video, converting the 3D image file to a first format configured to be accepted by a first digital advertising platform, generating a display advertisement including the 3D image file, displaying the display advertisement on a device through the first digital advertising platform.

Further, the computer-implemented method, apparatus, and non-transitory computer readable medium may provide for generating the display advertisement dependent upon receiving instructions for targeting preference determined by selection of types of electronic devices used, age of user, gender of user, location of user, average duration of engagement detected of the user, budget of an advertising campaign, type of web site or web page, or a combination thereof.

### BRIEF DESCRIPTION OF THE DRAWINGS

The present disclosure will become better understood from the detailed description and the drawings, wherein:

FIG. 1 shows an example of an advertisement generation and distribution platform in accordance with aspects of the present disclosure.

FIG. 2 shows an example of an image generation module in accordance with aspects of the present disclosure.

FIGS. 3A-C show an example of creating and customizing a 360 degree display ad banner in accordance with aspects of the present disclosure.

FIG. 3D shows an example of an ad banner displayed within a VR environment as a VR billboard in accordance with aspects of the present disclosure.

FIGS. 4A-B show an example creating and customizing a 360 degree video ad in accordance with aspects of the present disclosure.

FIG. 4C shows an example a 360 degree video ad displayed in a VR full screen mode in accordance with aspects of the present disclosure.

FIG. 5 shows an example of a process for generating and displaying a 360 degree ad banner on a device in accordance with aspects of the present disclosure.

FIG. 6 shows an example of a process for generating and displaying a 3D photo ad banner on a device in accordance with aspects of the present disclosure.

FIG. 7 shows an example of a process for generating and displaying a 360 degree video ad on a device in accordance with aspects of the present disclosure.

FIGS. 8-10 show an example of a platform for creating new and modifying existing 360 degree video or photo VR ads or experiences in accordance with aspects of the present disclosure.

FIG. 11 shows an example of creating an ad banner from 2D photos in accordance with aspects of the present disclosure.

FIG. 12 shows an example of a platform for promoting and managing 3D photo ad banners, 360 degree ad banners and videos in accordance with aspects of the present disclosure.

FIG. 13 shows an example of web tag generation for different ad exchanges and demand-side platforms in accordance with aspects of the present disclosure.

FIG. 14 shows an example of a platform for the analysis of the ad campaign performance in accordance with aspects of the present disclosure.

FIG. 15 shows an example of a 360 degree game in accordance with aspects of the present disclosure.

### DETAILED DESCRIPTION

In this specification, reference is made in detail to specific examples of the disclosure. Some of the examples or their aspects are illustrated in the drawings.

For clarity in explanation, the disclosure has been described with reference to specific examples, however it should be understood that the disclosure is not limited to the described examples. On the contrary, the disclosure covers alternatives, modifications, and equivalents as may be included within its scope as defined by any patent claims. The following examples of the disclosure are set forth without any loss of generality to, and without imposing limitations on, the claimed disclosure. In the following description, specific details are set forth in order to provide a thorough understanding of the present disclosure. The present disclosure may be practiced without some or all of these specific details. In addition, well known features may not have been described in detail to avoid unnecessarily obscuring the disclosure.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some examples are implemented by a computer system. A computer system may include a processor, a memory, and a non-transitory computer-readable medium. The memory and non-transitory medium may store instructions for performing methods and steps described herein.

The following generally relates to the creation and management of 3D photo ad banners, 360 degree ad banners, 360 degree video ads and 360 degree virtual reality (VR) ads and experiences.

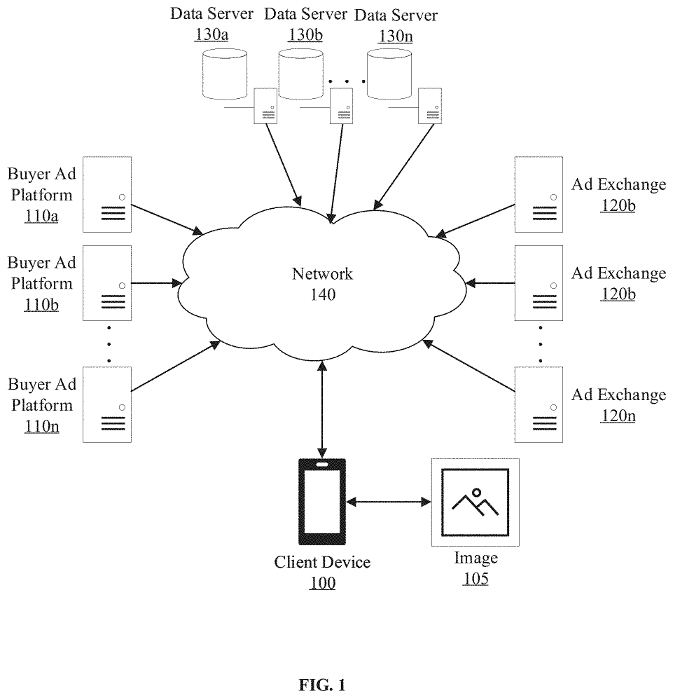

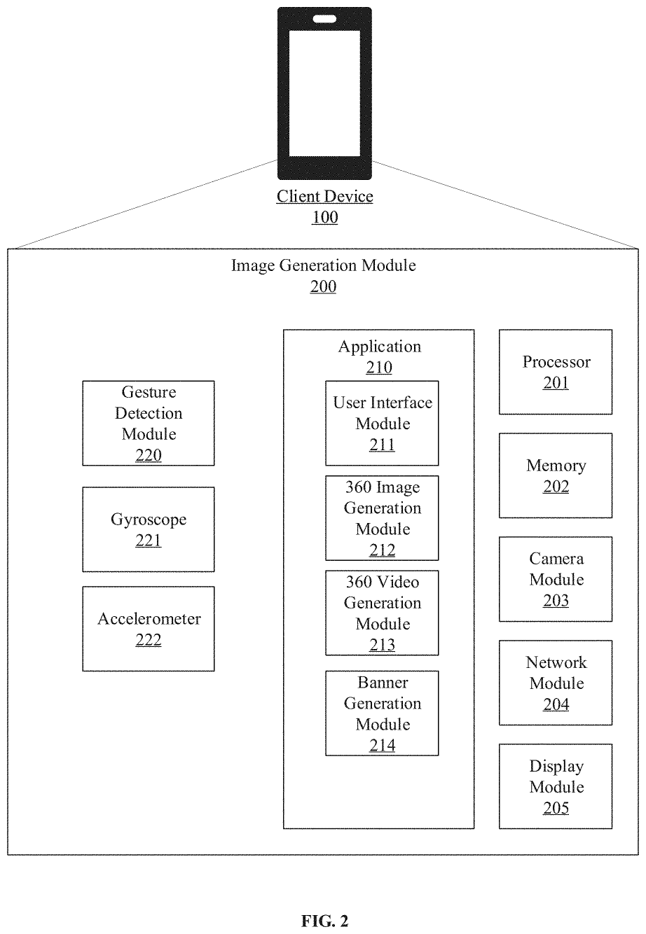

FIG. 1 shows an example of an advertisement generation and distribution platform in accordance with aspects of the present disclosure. The example shown includes client device 100, image 105, buyer ad platforms 110a-110n, ad exchanges 120a-120n, data servers 130a-130n and network 140. Client device 100 may be an example of, or include aspects of, the corresponding element or elements described with reference to FIG. 2.

In one embodiment, the advertisement creation, customization, management and distribution platforms and systems take one or more 2D or 3D images files, panoramic photos, panoramic videos, 360 degree photos, 360 degree 3D photos, 360 degree stereo photos, existing 360 degree ad banners, 360 degree videos, 360 degree 3D videos, 360 degree stereo videos or existing 360 degree video ads, and generate a new display advertisement, such as a new 360 degree ad banner or a new 360 degree video ad that may be displayed on a user device. The display advertisement may be used as content in a VR environment, website advertisement, in-app advertisement or any other advertisement avenue. The display advertisement may be distributed through a digital advertising platform that may be supported by internet browser webpages, mobile applications running on mobile device operating systems, desktop applications running on desktop operating systems, gaming or game engines, virtual reality engines, or a combination thereof.

In some embodiments, the client device 100 may be used for both creation of ad and VR content, as well as the displaying of such content. Content may be stored on the client device 100, buyer ad platforms 110a-110n, ad exchanges 120a-120n, data servers 130a-130n, or other networked data stores. The content may be transmitted over network 140 to and from the client device 100.

Embodiments of the advertisement creation, customization, management and distribution platforms and systems provide for the generation and displaying of display advertisements, such as ad banners, that include interactive 3D photo images, interactive 3D videos and interactive 3D objects, such as characters. The 3D images, videos and objects may be animated and responsive to user gestures such as cursor movement, cursor clicks, movement of the client device 100 or a combination thereof. The advertisement may be displayed on a website through an HTML5 compatible web browser, or on a mobile app operating on a smartphone.

The 360 degree ad banners, 360 degree video ads and 360 degree VR ads and experiences may be distributed via common web protocols (e.g. HTTP/HTTPS) and languages including hypertext markup language (HTML and JavaScript). In some embodiments, the system may be integrated with an existing ad building and editing software. For example, the image generation system workflow can be integrated as a plugin or custom template implementation. In some embodiments, an HTML output associated JavaScript renderer operates as a generic web component that can be used outside an ad application (for example, embedded as a 360 degree ad banner on a website).

360 degree advertisement experiences grab audiences' attention effectively, which makes the advertisement messages and visual graphics stand out. 360 degree advertisements may also be clearly distinguishable from surrounding content, which results in more effective advertising.

The VR environment disclosed, may allow a user to move around and navigate within a VR environment, interact with hotspots (e.g. points of interest) and objects, and view information related to objects or hotspots that are being focused on or selected. Selected objects or hotspots may link to another 2D image/video, slideshow, additional 360 degree VR experience, URL redirects, execute JavaScript, open a VR menu or link to any other content available. The VR environment may allow for a user to manipulate the position, orientation or other properties and parameters of an object or hotspot. The viewing angle of the environment and/or objects within the environment may be manipulated through gestures or based upon output from gyroscope 221 and/or accelerometer 222.

The VR environment and ad banners may take the form of 360 degree video, adaptive 360 degree video streams, 360 degree photos, stereoscopic 360 degree video, 180 degree side-by-side 3D video or panoramic photos. The system may allow for a user to change the field of view of the camera, switch between different display modes and display/video formats.

Client device 100, may receive an image 105 from a user via a web based interface which allows a user to upload an image file. Image 105 may be a 2D image that needs to be converted to a 3D image, a 3D image file, a 3D photo image, panoramic photo, panoramic video, 360 degree stereo photo, 360 degree stereo video, 360 degree photo or 360 degree video. The 3D or 360 degree content may then be converted into a format for one or more buyer ad platforms 110a-110n or ad exchanges 120a-120n. The converting may also generate tags that may be embedded in websites, mobile applications or social media.

The 360 degree content may be used in the generation of display advertisements for advertisement campaigns. The 360 degree advertisement may be as ad banner that allows for user interaction with the 360 degree environment and object within the environment. User input and gestures may be detected through input device and sensors.

The generated 360 degree display advertisement may then be distributed across the internet and displayed on a device through the buyer ad platforms 110a-110n and the ad exchanges 120a-120n. The generated tags allow for content to be distributed in any format required by the individual exchanges and platforms.

Thus, the present disclosure provides efficient means of creating, customizing and distributing 3D photo ad banners, 360 degree ad banners, 360 degree video ads and 360 degree VR ads and experiences. 3D photo ads and 360 degree ad experiences grab audiences' attention effectively, which makes the ad messages and visual graphics stand out. 3D photo ads and 360 degree ads may also be clearly distinguishable from surrounding content, which results in more effective advertising.

Additionally, the present disclosure provides for easier ad monetization by installing omnivirt sdk into websites, apps, games and other distributed media. VR/AR games may use In-App Advertisements in monetization through including ad content within their VR/AR environments. Users of these environments may interact with the advertisements while simultaneously navigating or participating in the gaming experience. 3D photo ad banners, 360 degree ad banners and 360 degree video ads may increase the number of impressions an advertisement receives on websites and apps, maximizing monetization.

FIG. 2 shows an example of an image generation module on a client device in accordance with aspects of the present disclosure. Image generation module 200 may be an example of, or include aspects of, the corresponding element or elements described with reference to FIG. 1. In an embodiment, image generation module 200 is a component or system on client device 100. In other embodiments, image generation module 200 comprises buyer ad platforms 110a-110n or ad exchanges 120a-120n, or is a component or system on peripherals or third-party devices. Image generation module 200 may comprise hardware or software or both.

Image generation module 200 may include processor 201, memory 202, camera module 203, network module 204, display module 205, application 210, user interface module 211, 360 image generation module 212, 360 video generation module 213, banner generation module 214, gesture detection module, gyroscope 221 and accelerometer 222.

A processor 201 may include an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor 201 may be configured to operate a memory array using a memory controller. In other cases, a memory controller may be integrated into processor 201. The processor 201 may be configured to execute computer-readable instructions stored in a memory to perform various functions related to generating 360 degree content.

Memory 202 may include random access memory (RAM), read-only memory (ROM), or a hard disk. The memory 202 may be solid state or a hard disk drive, and may store computer-readable, computer-executable software including instructions that, when executed, cause a processor to perform various functions described herein. In some cases, the memory 202 may contain, among other things, a BIOS which may control basic hardware or software operation such as the interaction with peripheral components or devices. In some cases, a memory controller may operate memory cells as described herein.

Camera module 203 may include any camera or combination of cameras configured to record video data. The cameras may be any type of image sensor which provides an image of a scene viewed from the viewpoint of the device and/or user. The cameras may be any device configured to detect visible light (e.g. CCD or CMOS based cameras) or light of other spectrums (e.g. multi-spectral or hyper-spectral cameras), such as infrared, ultraviolet, x-rays or any other wavelength the device is capable of detecting. Other types of cameras are possible as well, such as a time-of-flight camera, stereoscopic cameras or other camera combinations capable of determining depth of a captured image/video. The camera module 203 may include hardware and/or software to enable the use of structured light depth determination or time-of-flight depth determination. Camera module 203 may also be other types of range detectors, such as LIDAR sensors or ultrasonic transceivers. Camera module 203 may also be a combination of two or more of the devices described above.

Network module 204 may transmit and receive data and receive data from other computing systems via a network. In some embodiments, the network component 204 may enable transmitting and receiving data from the Internet. Data received by the network component 204 may be used by the other modules. The modules may transmit data through the network component 204.

Display module 205 may be a touch-screen display, a head-up display, a head-mounted display, an optical see-through display, an optical see-around display, a video see-through display, a flat-panel display, a light-emitting diode (LED) display, an electroluminescent display (ELD), an electrophoretic display (EPD or electronic paper), a liquid crystal display (LCD), an organic LED (OLED) display, an active-matrix organic light-emitting diode display or any other type of display.

Application 210 may include user interface module 211, 360 image generation module 212, 360 video generation module 213 and banner generation module 214.

User interface module 211 may provide a user with functionality such as uploading of images and 360 degree content, selection of 360 degree content, creating 360 degree advertisements, customizing 360 degree advertisements, promoting ad campaigns, managing ad campaigns and analyzing the performance of ad campaigns.

User interface module 211 may interact with 360 image generation module 212, 360 video generation module 213 and banner generation module 214 by serving uploaded or selected content to the modules. User interface may also receive 360 degree ad content from the modules and allow for a user to deploy and promote an ad campaign comprising the 360 degree ad content on exchanges and platforms over the internet.

360 image generation module 212 may receive one or more 2D images, panoramic images or videos. 360 degree video may be used to create a 360 degree ad banner by extracting frames from the video. The 360 degree image need not encompass the entire 360 degree field of view, and another angle may be used in the generation of the images, such as 180 degree images. The 360 degree image content may be generated as an advertisement to be displayed on a website, mobile application or VR experience.

The 360 image generation module may allow for a user to modify, customize or otherwise edit the created 360 degree image. The user may add one or more hotspots to the 360 degree image that may link to other actions or content. Hotspots may be interactive and/or animated. Hotspot indicators may be displayed so as to inform the user of the existence of addition content than they may interact with. In some embodiments, hotspots may be animated in such a way as to draw a user's attention to them.

360 video generation module 213 may receive one or more 360 degree video or 2D video. The 360 degree video need not encompass the entire 360 degree field of view, and another angle may be used in the generation of the videos, such as 180 degree images. The 360 degree video content may be generated as an advertisement to be displayed on a website, mobile application or VR experience.

Banner generation module 214 may receive one or more 3D images, 360 degree images, 360 degree video, 2D or 3D movies or other content to be displayed on an ad banner. Banner generation module may be configured to create 3D photo ad banners and/or 360 degree ad banners for display within a VR environment. Within a VR environment, the banner generation module 214, may create a virtual billboard in which a 2D image or video are displayed attached to a surface. Integration of ad banners within VR environments allows for advertisements to be highly visible without interfering with the VR experience.

Ad banners such as those described, may allow a user to interact with objects in a manner similar to that of interactions with VR environment objects as described above. Within the ad banner, objects may perform automatic or default animations when displayed on a mobile app or website. The animation can be halted upon scrolling away from the ad banner. Upon detection of inactivity of the user, one or more of the objects within the ad banner may be animated in such a way as to draw the attention of the user back to the ad banner. Examples of animation intended to grab a user's attention may include explosions, rapid movement, flashing, changes of color or patterns, waving of virtual characters arms, objects or characters mimicking emotions (e.g. sad, angry or disappointed) or audible sounds that would virtually emanate from the object, ad banner or products. Alternatively, upon detection of inactivity, the default animation of the object may be displayed.

In one embodiment, the user scrolling a page up or scrolling a page down on the device may cause the 3D photo ad banner to be zoomed in or zoomed out. In one embodiment, the 3D photo ad banner may be initialized in a zoomed out state and the 3D photo ad banner may be below the user's current scroll position. As the user scrolls down to the 3D photo ad banner, it zooms in to the 3D photo ad banner. When the user scrolls past the 3D photo ad banner, the 3D photo ad banner may be zoomed out as the user continues to scroll down. The scrolling may be on a mobile or desktop device.

In one embodiment, the 3D photo ad banner OR 360 degree ad banner automatically pans up, down, left, and/or right even when there is no user input. This shows the user that the ad banner is a 3D photo ad banner or 360 degree ad banner and not just a flat ad banner.

In one embodiment, as the user moves a cursor or other interaction point on the screen, the 3D image pans in that direction. For example, if the user moves the cursor or interaction point to the right, then the view of the 3D image pans to the right. Likewise, the same occurs for moving the cursor or interaction point to the left, up, or down.

360 degree ad banners may display 360 degree video or images that may be interacted with in a similar fashion as the ad banners described above.

Gesture detection module 220 may receive as input, data collected by camera 203, gyroscope 221, accelerometer 222, or any other sensor provided on the client device 100, worn on a user, or disposed within the user's environment. The gesture input collected may be related to a user interacting with a 360 degree VR environment, the device or 360 degree ad content.

Gesture inputs may include, but are not limited to, movement of the client device 100, such as tilting, rotating, shaking, accelerating, or reorienting of the client device 100 in any way. Client device 100 may be a smartphone, tablet or other handheld computing devices. The gestures may be combinations of movements, repetitions of movements, or durations of movements.

Gesture inputs may further include, but are not limited to, touch and multi-touch operations performed by a user on a touch screen device. Gestures may include swipe or flick, which may cause the display to reorient or dismiss content. A user may perform a pinch gesture with two or more fingers to zoom or select content. Other gestures that include contact and/or movement/number of the contacted points may also be detected.

Gesture detection module 220 may also capture real-time video from a back facing camera of a client device 100 while simultaneously capturing video with a front facing camera of the client device 100 of hand gestures performed by a user in free space in front of the device.

Gesture detection module 220 may also recognize compound gestures such as detecting gestures by both cameras at the same time and start a gesture in the view of one camera and complete the gesture in the view of the second camera. These compound gestures may also include a detecting a combination of any of the above described gestures through multiple sensor, devices or modules, simultaneously and in real-time.

Gesture detection module 220 may associate gestures separately to the ad type being interacted with. 360 degree ad banners may include gestures such as swipe, tilt, rotate and drag. These gestures may cause a change in the 360 degree ad banner viewing angle. A touch or click gesture anywhere on the 360 degree ad banner may result in the opening of 360 degree content or the redirecting of the user to the ad destination URL. A touch or click gesture on a button within the 360 degree ad banner may also result in the opening of 360 degree content and the redirecting of the user to the ad destination. A scroll gesture may result in the change viewing angle change for the user.

3D photo ad banners may have multiple gestures associated with them, and may result in different actions and results than that of the 360 degree ad banner. 3D photo ad banners may include gestures such as swipe, tilt, rotate and drag. These gestures may cause a change in the 3D photo ad banner viewing angle. A touch or click gesture anywhere on the 3D photo ad banner may result in the redirecting of the user to the ad destination URL. A scroll gesture may result in the zooming in and out of the 3D photo ad banner.

360 degree video ads may have multiple gestures associated with them, and may result in different actions and results than that of the 360 degree ad banner and 3D photo ad banner. 360 degree video ads may include gestures such as swipe, tilt, rotate and drag. These gestures may cause a change in the 360 degree video ad viewing angle. A touch or click gesture on a button within the 360 degree video ad may result in the redirecting of the user to the ad destination URL.

Gyroscope 221 may be any device configured for measuring or maintaining orientation, based on the principles of conservation of angular momentum. Gyroscopes can be mechanical, electronic and/or micro-electro-mechanical systems (MEMS) gyroscope devices. Gyroscope 221 may be a plurality of the above described device, as well as a combination of the above described devices. The gyroscope 221 may be used in combination with the accelerometer 222, and other sensors known in the art to determine orientation, location, and pose of the client device 100, or the user.

Accelerometer 222 may be any device capable of measuring the physical acceleration of the client device 100. Accelerometer may be an electronic device capable of detection acceleration of the device, converting the detected acceleration to an electrical signal, performing conversion from an analog signal to a digital signal, and providing the converted information to a processor, subsystem or module within the client device 100.

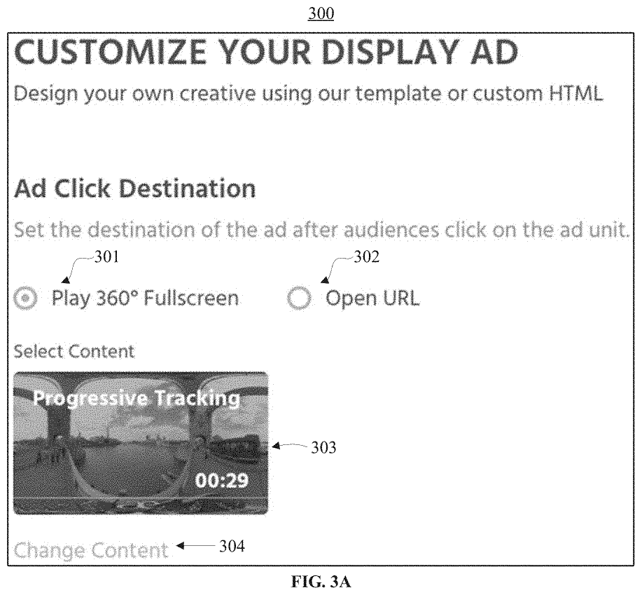

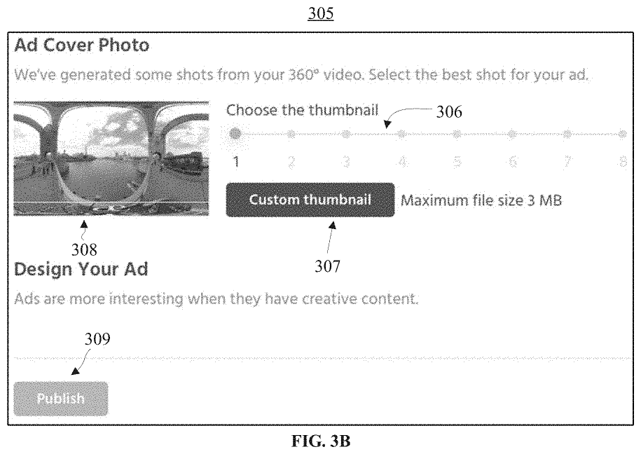

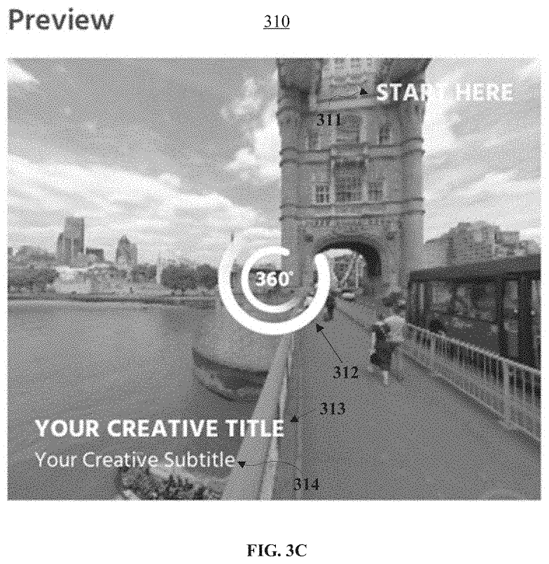

FIG. 3A shows an example of ad banner customization interface 300 in accordance with aspects of the present disclosure. The ad banner customization interface may include ad click customizations 301 and 302, content selector 303, and a change content link 304. In some cases, the operations of this interface may refer to, or be performed by, a user interface module 211, banner generation module 214, or combination thereof, as described with reference to FIG. 2.

Ad banner customization interface 300 may be used in the selection of content to be displayed in the ad banner as well as the customization of events performed when interacted with by a user. Ad click customization 301 may be selected to give the ad button 311, with relation to FIG. 3C, the functionality to launch the 360 degree content in a full screen mode. Ad click customization 302 may be selected to give the ad button 311 the functionality to redirect the user to a URL. Other functionality not show in FIG. 3A may be provided for selection as an ad click customization, and the disclosure of embodiments is not limiting.

Content selector 303 may be in the form of a button or icon to be selected by the user. Upon selection of the content selector 303, a user may be presented, in the same or separate interface (e.g. popup), options for adding content to the ad banner. The content may be created beforehand and stored on data servers 130a-130n or other storage device connected to network 140. The user may also be given the option to create new content that is to be included in the ad banner, as well as the option to edit, modify or further customize the newly created or previously created content. Upon selection of the content, the content selector 303 may display a thumbnail or other representation of the content. This representation may also include information relating to properties of the content and other information pertinent to the creation and/or customization of the ad banner.

Change content link 304 may be selected by the user to modify or change the previously selected content. When selected, the change content link 304 may provide an interface similar to that of the content selector. Content may be switched with different content, or modified, customized or edited before the completion and publishing of the ad banner.

The ad banner customization interface 300 may also allow a user to enter one or more lines of text, one or more logos, one or more 2D images, one or more 2D graphics, one or more 2D animations, a background image, or combination thereof. The 3D photo image, 360 degree content, and other 2D content, may be configured for engagement when the user is viewing and/or interacting with the ad banner.

FIG. 3B shows an example of a thumbnail selection interface 305 in accordance with aspects of the present disclosure. The thumbnail selection interface 305 may include a thumbnail selector 306, thumbnail customizer 307, thumbnail preview 308 and a publish button 309.

Thumbnail selection interface 305 may be used to select or modify an ad cover photo that represents the content of the ad banner. One or more thumbnails may be generated to represent the content of the ad banner. Thumbnails may be generated from 360 degree video frames at predetermined intervals. Thumbnails may also be generated based upon analysis of 360 degree videos or photos. Such analysis may determine that a frame difference between two timesteps and/or viewing angles is greater than a threshold, and thus would be a good candidate for a thumbnail. Thumbnails may also be generated for different user interaction scenarios and the respective content responses to such interactions. Thumbnail customizer 307 may allow for a user to upload their own ad cover photo from device 100.

FIG. 3C shows an example of a 360 degree ad banner preview being displayed on a web browser in accordance with aspects of the present disclosure. In an embodiment, ad banner preview 310 is a 360 degree image or panorama image. The ad banner preview 310 allows a user to interact with the ad banner while still in the creation, customizing or editing phase, before submitting or publishing the ad banner. The ad banner preview 310 may display all content that the final ad banner will contain. The ad banner preview 310 may be updated in real-time as the user makes changes to the content or properties of the ad banner. For example, ad banner preview 310 may display content such as an ad button 311, interaction indicator 312, ad title 313 and ad subtitle 314.

Ad button 311 may perform an action upon being selected. The action may be to play the ad in 360 full screen if option 301 was previously selected, or opening a URL if option 302 was previously selected. Interaction indicator 312 may be animated before, during and after a user's interaction. The indicator may be an image or icon that may also act as a visual representation of the interaction to be performed.

FIG. 3D shows an example of an ad banner being displayed as an ad billboard 316 within a VR environment 315, being executed on a client device 100, such as a mobile device or HMD in accordance with aspects of the present disclosure. VR environment 315 may provide for a fully interactive, 360 degree video or immersive VR game experience, that allows a user to navigate to different locations within the VR environment. Ad billboard 316 may be placed against walls, floors or surfaces, or wrapped around objects in such a way as to not obstruct the user's experience. The ad billboard 316 may be interactive in nature, and may be distributed and displayed the web browser of mobile devices, laptops or desktop computers, as well as mobile applications on mobile devices, or a combination thereof.

The ad billboard 316 may be displayed and interacted with through the use of a virtual reality engine, virtual reality room, virtual reality application, virtual reality marketplace, virtual reality in-game, or a combination thereof. The ad billboard 316 may be an ad banner that contains a 3D image file, background image, virtual objects, advertisement text, links, buttons, graphic overlays, or any other 2D or 3D content.

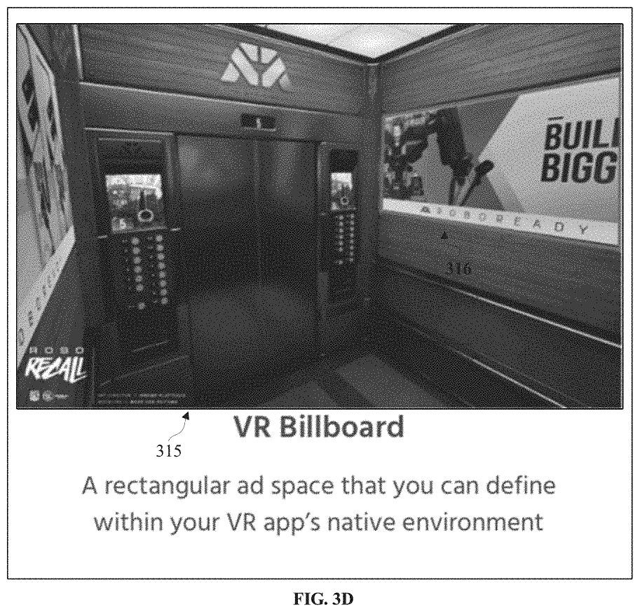

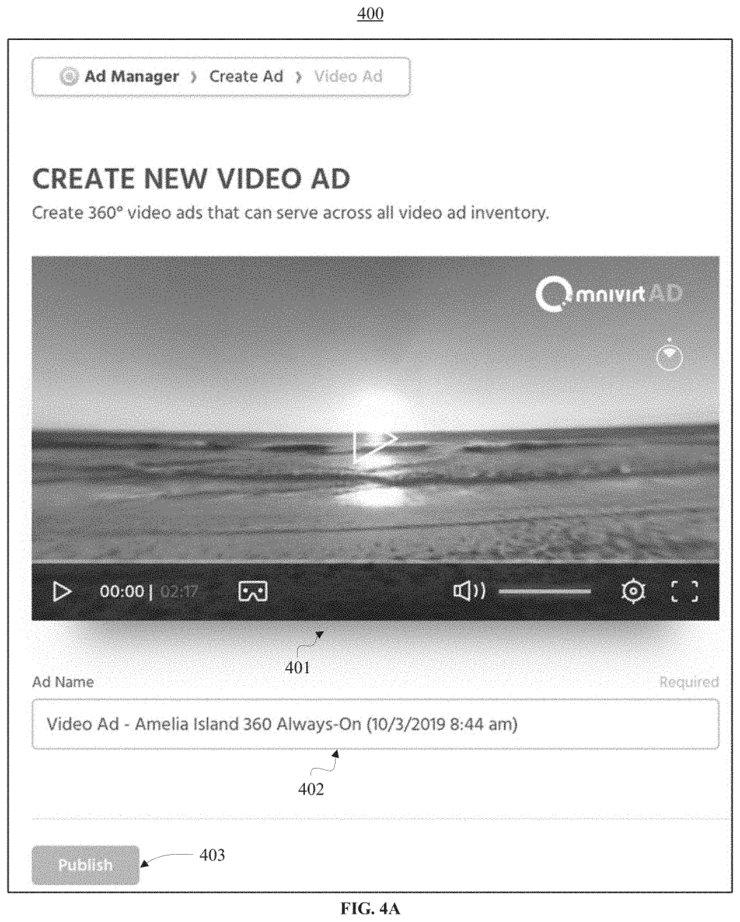

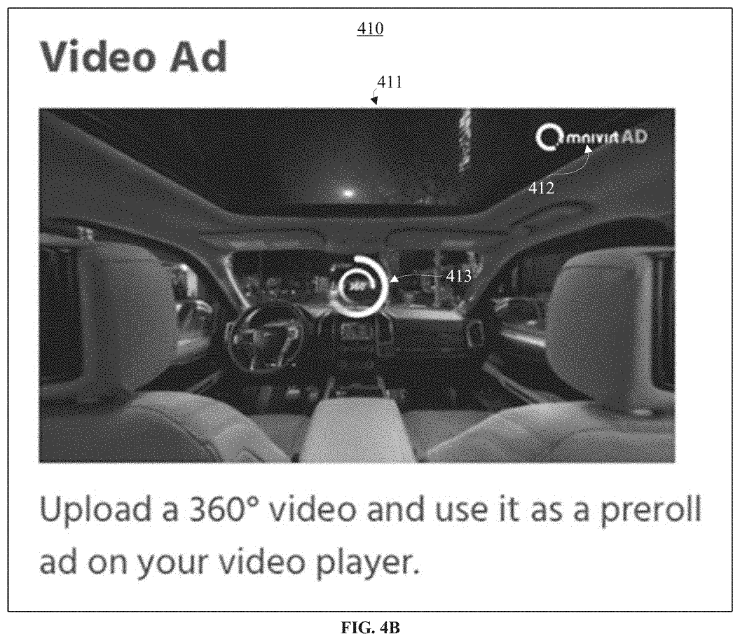

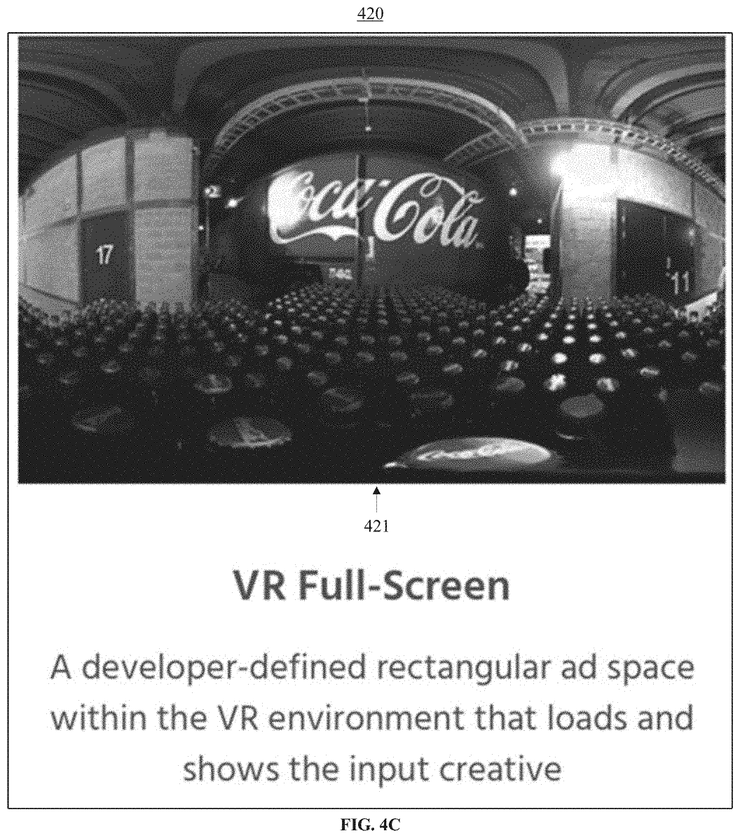

FIG. 4A shows an example of a video ad creation interface 400 in accordance with aspects of the present disclosure. Video ad creation interface 400 may include 360 degree video 401, ad name 402, and a publish button 403. The video ad creation interface 400 may allow a user to upload or select a 360 degree video, panorama video, 2d video, add and/or modify advertisement text, as well as 2D, panorama or 360 degree videos to be displayed in the video ad, and buttons and links that may trigger other actions or content upon selection, or other properties and content that a user wishes to be included with the 360 degree video ad. In some cases, the operations of this interface may refer to, or be performed by, a user interface module 211, 360 degree video generation module 213, or combination thereof, as described with reference to FIG. 2.

FIG. 4B shows an example of a 360 degree video ad 410 in accordance with aspects of the present disclosure. The 360 degree video ad 410 may include 360 degree video 411, advertisement text 412, and interaction indicator 413. The 360 degree video ad 410 may be generated by the 360 degree video generation module 213 from content selected, uploaded, or entered by the user through the user interface module 211. The 360 degree video ad 410 may be created by overlaying one or more lines of text and/or buttons.

FIG. 4C shows an example of a 360 degree VR ad 420 in accordance with aspects of the present disclosure. 360 degree VR ad 420 may be launched in full screen while within a VR environment. The 360 VR ad 420 may include 360 degree video 421. The 360 degree video 421 may be interactively displayed on a mobile application of a mobile device, an internet web browser of a mobile device, or laptop or desktop computer, or a combination thereof. The 360 degree VR ad 420 may be displayed and interacted with in a full screen mode, which occupies the entirety of the VR experience, through the use of a virtual reality engine, virtual reality room, virtual reality application, virtual reality marketplace, virtual reality in-game, or a combination thereof.

The 360 degree VR ad 420 may also be the interactive VR environment and not just an advertisement within a separate VR experience. The 360 degree VR ad 420 may be in the form of an interactive game which promotes or ties into an advertisement campaign. The 360 degree VR ad 420 may also include 360 degree video, interactive 3D objects, hotspots, and other 3D or 360 degree content.

FIG. 5 shows an example of an overview of a process for generating and displaying display 360 degree ad banners from uploaded photo/video files in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 500, the system receives an uploaded 360 degree photo, 360 degree video, panorama photo, panorama video, 2D photo or 2D video file. In some cases, the operations of this step may refer to, or be performed by, a user interface module 211 as described with reference to FIG. 2. For example, the photo/video file may be uploaded from a client device 100.

At step 505, the system receives image overlays and ad click destinations from the user. 2D image overlays may include text, logos, 360/2D images or videos and ad destinations associated with the overlays.

At step 510, the system converts the uploaded photo/video file to 360 degree image for ad cover. In some cases, the operations of this step may refer to, or be performed by, a banner generation module 214 as described with reference to FIG. 2. For example, the 360 degree image can be converted into an ad tag in various formats for distributing 360 degree image ad banners to other ad exchanges and demand-side platforms. Ad tags may be formatted for embedding on selected exchanges or platforms or all platforms and may be displayed to the user in a manner that allows the user to copy the embedding code for the selected exchange or platform. The code to be embedded may be created beforehand for all of the exchanges and platforms, only some of the exchanges and platforms or none of the exchanges and platforms. When code is not generated beforehand, the code may be generated upon request, in real time, on a client device 100, buyer ad platform 110a-n and/or ad exchange 120a-n. The system may also generate code based on user preferences, learned user habits, or learned preferences from groups of users. Groups can be clustered by demographic information of users and/or ad campaign managers, industry, company size, location or any other classifiable, clusterable or generally learnable groups.

At step 515, the system generates a display advertisement including the 360 degree image and overlays received from step 505. In some cases, the operations of this step may refer to, or be performed by, 360 image generation module 212, 360 video generation module 213 or banner generation module 214 as described with reference to FIG. 2. The system may generate a new display advertisement, such as a new 360 degree ad banner which may be displayed on a user device. Generation of the new 360 degree ad banner may also include the overlaying of text, logos, 360/2D images or videos and ad destinations associated with the overlays. The ad destination may be another 360 degree content or an external URL.

At step, 520 system displays the 360 degree ad banner on a device. In some cases, the operations of this step may refer to, or be performed by, a display module 205 as described with reference to FIG. 2. For example, the 360 degree ad banner may be used as content in a VR environment, website advertisement, in-app advertisement or any other advertisement avenue. The display advertisement may be distributed through a digital advertising platform that may be supported by internet browser webpages, mobile applications running on mobile device operating systems, desktop applications running on desktop operating systems, gaming or game engines, virtual reality engines, or a combination thereof.

At step 525, the 360 degree ad banner may be promoted on an ad exchange and/or platform. The user may upload the 360 degree ad banner manually to the exchange and/or platform. The system may automatically upload the 360 degree ad banner to preselected exchanges and/or platforms. The system may store the preselected exchanges and/or platforms in a user profile, which may be modified and saved by the user.

At step 530A, the system interactively displays the 360 degree ad banner on a mobile device. A mobile application running on the mobile device may incorporate the 360 degree ad banner into the applications user interface. The ad banner may also be displayed in a full screen mode during normal operation of the mobile application. The full screen ad banner may be triggered by interactions of the user with the mobile application, inactivity of the user, input from sensors embedded within or connected to the mobile device, at predetermined times, based on duration of user activity, or at predetermined time intervals. A user may interact with the displayed ad banner through gesture inputs. A user may move or manipulate the mobile device itself in order to generate gesture inputs. Rotating, shaking, accelerating, reorienting, or combination thereof, of the mobile device may be linked to specific animations, actions, or functions of the ad banner or the content within the ad banner. The interactions of the user may cause the viewpoint to change, zooming in or out on content, rotation or translation of content, transformation of content, and the performance of predetermined actions and animations related to the ad banner and its content. The gestures may also be combinations of movements, repetitions of movements, or durations of movements. Gesture inputs may further include, but are not limited to, touch and multi-touch operations performed by a user on a touch screen device. Gestures such as swipe, tab, or flick may be used, but other gestures that include contact and/or movement/number of the contacted points may be detected.

At step 530B, the system interactively displays the 360 degree ad banner on an internet web browser of a mobile device, or laptop or desktop computer, or a combination thereof. Web browser may be an HTML5 compatible web browser, a browser with an embedded media player, or a plugin capable of displaying the ad banner. The 360 degree ad banner may be distributed via common web protocols and languages including hypertext markup language (HTML). In some embodiments, an HTML output associated JavaScript renderer operates as a generic web component that can be used outside an ad application (for example, embedded as a 360 degree photo on a website). Interactions may include gestures such as scrolling up/down to adjust the viewing angle of the 360 degree ad banner. The scrolling may be on a mobile or desktop device.

At step 530C, the system interactively displays the 360 degree ad banner on a virtual reality engine, virtual reality room, virtual reality application, virtual reality marketplace, virtual reality in-game, or a combination thereof. The 360 degree ad banner may be a full screen 360 degree ad banner displayed within the VR environment or a VR billboard advertisement that is attached to a surface within the VR environment without taking up a significant portion of the screen. When the 360 degree ad banner is a VR billboard, the user may interact with the 360 degree ad banner in a similar manner to that of the interaction with a 360 degree ad banner displayed on a web browser as is described previously. When the ad banner is a full screen 360 degree ad banner displayed in the VR environment, the ad banner may be interacted with in a manner similar to that of the interaction with a full screen 360 degree ad banner displayed on a mobile application as is described previously.

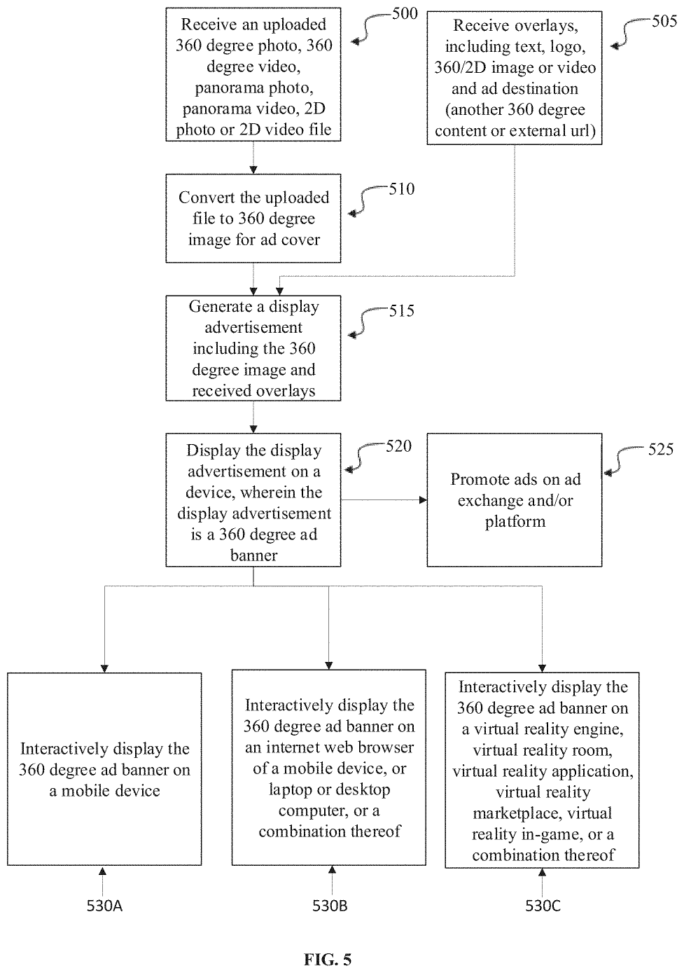

FIG. 6 shows an example of an overview of a process for generating and displaying 3D photo ad banners from uploaded 3D image files in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 600, the system receive an uploaded 3D image file. In some cases, the operations of this step may refer to, or be performed by, a user interface module 211 as described with reference to FIG. 2. For example, the 3D image file may be uploaded from a client device 100. 3D image file may be a 2D photo plus depth map or previously generated 3D content. 3D image file may be generated from a 2D image and associated depth map. The depth map may be uploaded by a user or generated based on the 2D photo.

At step 605, the system receives a 2D image overlay and ad click destination from the user. 2D image overlays may include one or more lines of text, one or more logos, one or more two dimensional (2D) images, one or more 2D graphics, one or more 2D animations, a background image, or a combination thereof.

At step 610, the system converts the 3D image file to a first format configured to be accepted by a first digital advertising platform. In some cases, the operations of this step may refer to, or be performed by, a banner generation module 214 as described with reference to FIG. 2. For example, the 3D image file can be converted into an ad tag in various formats for distributing 3D photo ad banners to other ad exchanges and demand-side platforms. Ad tags may be formatted for embedding on selected exchanges or platforms or all platforms and may be displayed to the user in a manner that allows the user to copy the embedding code for the selected exchange or platform. The code to be embedded may be created beforehand for all of the exchanges and platforms, only some of the exchanges and platforms or none of the exchanges and platforms. When code is not generated beforehand, the code may be generated upon request, in real time, on a client device 100, buyer ad platform 110a-n and/or ad exchange 120a-n. The system may also generate code based on user preferences, learned user habits, or learned preferences from groups of users. Groups can be clustered by demographic information of users and/or ad campaign managers, industry, company size, location or any other classifiable, clusterable or generally learnable groups.

At step 615, the system generates a display advertisement including the converted 3D image file and overlays received from step 605. In some cases, the operations of this step may refer to, or be performed by, 360 image generation module 212 or banner generation module 214 as described with reference to FIG. 2. The system may generate a new display advertisement, such as a new 3D photo ad banner which may be displayed on a user device. Generation of the new display advertisement may also include the overlaying of 2D content onto the converted 3D image file, and associating ad click destinations with the overlayed content.

At step 620, the system displays the display advertisement on a device, wherein the display advertisement is a 3D photo ad banner comprising the converted 3D image file, one or more lines of text, one or more logos, one or more two dimensional (2D) images, one or more 2D graphics, one or more 2D animations, a background image, or a combination thereof. In some cases, the operations of this step may refer to, or be performed by, a display module 205 as described with reference to FIG. 2. For example, the 3D photo ad banner may be used as content in a VR environment, website advertisement, in-app advertisement or any other advertisement avenue. The 3D photo ad banner may be distributed through a digital advertising platform that may be supported by internet browser webpages, mobile applications running on mobile device operating systems, desktop applications running on desktop operating systems, gaming or game engines, virtual reality engines, or a combination thereof.

At step 625, the 3D photo ad banner may be promoted on an ad exchange and/or platform. The user may upload the 3D photo ad banner manually to the exchange and/or platform. The system may automatically upload the 3D photo ad banner to preselected exchanges and/or platforms. The system may store the preselected exchanges and/or platforms in a user profile, which may be modified and saved by the user.

At step 630A, the system interactively displays the 3D photo ad banner on a mobile device. A mobile application running on the mobile device may incorporate the 3D photo ad banner into the applications user interface. The ad banner may also be displayed in a full screen mode during normal operation of the mobile application. The full screen ad banner may be triggered by interactions of the user with the mobile application, inactivity of the user, input from sensors embedded within or connected to the mobile device, at predetermined times, based on duration of user activity, or at predetermined time intervals. A user may interact with the displayed ad banner through gesture inputs. A user may move or manipulate the mobile device itself in order to generate gesture inputs. Rotating, shaking, accelerating, reorienting, or combination thereof, of the mobile device may be linked to specific animations, actions, or functions of the ad banner or the content within the ad banner. The interactions of the user may cause the viewpoint to change, zooming in or out on content, rotation or translation of content, transformation of content, and the performance of predetermined actions and animations related to the ad banner and its content. The gestures may also be combinations of movements, repetitions of movements, or durations of movements. Gesture inputs may further include, but are not limited to, touch and multi-touch operations performed by a user on a touch screen device. Gestures such as swipe, tab, or flick may be used, but other gestures that include contact and/or movement/number of the contacted points may be detected.

At step 630B, the system interactively displays the 3D photo ad banner on an internet web browser of a mobile device, or laptop or desktop computer, or a combination thereof. Web browser may be an HTML5 compatible web browser, a browser with an embedded media player, or a plugin capable of displaying the ad banner. The 3D photo ad banner may be distributed via common web protocols and languages including hypertext markup language (HTML). In some embodiments, an HTML output associated JavaScript renderer operates as a generic web component that can be used outside an ad application (for example, embedded as a 3D photo on a website). Interactions may include gestures such as scrolling a page up or scrolling a page down on the device, which may cause the 3D photo ad banner to be zoomed in or zoomed out. In one embodiment, the 3D photo ad banner may be initialized in a zoomed out state and the 3D object may be below the user's current scroll position. As the user scrolls down, the 3D photo ad banner zooms in. When the user scrolls past the 3D photo ad banner, the 3D photo ad banner zooms out as the user continues to scroll down. The scrolling may be on a mobile or desktop device.

In one embodiment, as the user moves a cursor or other interaction point on the screen, the 3D photo ad banner pans in that direction. For example, if the user moves the cursor or interaction point to the right, then the view of the 3D photo ad banner pans to the right. Likewise, the same occurs for moving the cursor or interaction point to the left, up, or down.

At step 630C, the system interactively displays the 3D photo ad banner on a virtual reality engine, virtual reality room, virtual reality application, virtual reality marketplace, virtual reality in-game, or a combination thereof. The 3D photo ad banner may be a full screen 3D photo ad banner displayed within the VR environment or a VR billboard advertisement that is attached to a surface within the VR environment without taking up a significant portion of the screen. When the 3D photo ad banner is a VR billboard, the user may interact with the 3D photo ad banner in a similar manner to that of the interaction with a 3D photo ad banner displayed on a web browser as is described previously. When the ad banner is a full screen 3D photo ad banner displayed in the VR environment, the ad banner may be interacted with in a manner similar to that of the interaction with a full screen 3D photo ad banner displayed on a mobile application as is described previously.

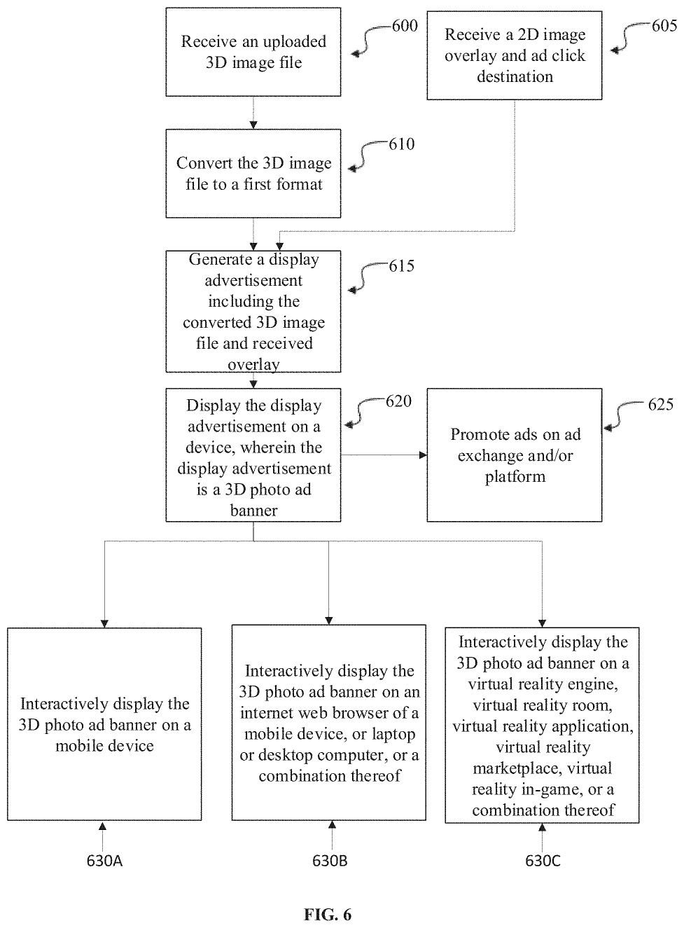

FIG. 7 shows an example of an overview of a process for generating and displaying 360 degree video ads from uploaded video files in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 700, the system receives an uploaded 360 video, panorama video or 2D video file. In some cases, the operations of this step may refer to, or be performed by, a user interface module 211 as described with reference to FIG. 2. For example, the video file may be uploaded from a client device 100.

At step 705, the system receives overlays and ad click destinations from the user. Overlays may include text and buttons and ad destination associated with the overlays.

At step 710, the system generates a display advertisement including the uploaded video file and overlays received from step 705. In some cases, the operations of this step may refer to, or be performed by, 360 image generation module 212, 360 video generation module 213 or banner generation module 214 as described with reference to FIG. 2. The system may generate a new display advertisement, such as a new 360 degree video ad which may be displayed on a user device. Generation of the new 360 degree video ad may also include the overlaying of text, and buttons and ad destinations associated with the overlays. The ad destination may be an external URL.

At step 715, the system displays the display advertisement on a device, wherein the display advertisement is a 360 degree video ad comprising the uploaded video file. In some cases, the operations of this step may refer to, or be performed by, a display module 205 as described with reference to FIG. 2. For example, the display advertisement may be used as content in a VR environment, website advertisement, in-app advertisement or any other advertisement avenue. The display advertisement may be distributed through a digital advertising platform that may be supported by internet browser webpages, mobile applications running on mobile device operating systems, desktop applications running on desktop operating systems, gaming or game engines, virtual reality engines, or a combination thereof.

At step 725, the 360 degree video ad may be promoted on an ad exchange and/or platform. The user may upload the 360 degree video ad manually to the exchange and/or platform. The system may automatically upload the 360 degree video ad to preselected exchanges and/or platforms. The system may store the preselected exchanges and/or platforms in a user profile, which may be modified and saved by the user.

At step 725A, the system interactively displays the 360 degree video ad on a mobile device. A mobile application running on the mobile device may incorporate the 360 degree video ad into the applications user interface. 360 degree video ad may also be displayed in a full screen mode during normal operation of the mobile application. The full screen 360 degree video ad may be triggered by interactions of the user with the mobile application, inactivity of the user, input from sensors embedded within or connected to the mobile device, at predetermined times, based on duration of user activity, or at predetermined time intervals. A user may interact with the displayed 360 degree video ad through gesture inputs. A user may move or manipulate the mobile device itself in order to generate gesture inputs. Rotating, shaking, accelerating, reorienting, or combination thereof, of the mobile device may be linked to specific animations, actions, or functions of the 360 degree video ad or the content within the 360 degree video. The interactions of the user may cause the viewpoint to change or the redirecting of the user to an external URL. The gestures may also be combinations of movements, repetitions of movements, or durations of movements. Gesture inputs may further include, but are not limited to, touch and multi-touch operations performed by a user on a touch screen device. Gestures such as swipe, tab, or flick are common in the art, but other gestures that include contact and/or movement/number of the contacted points may be detected.

At step 725B, the system interactively displays the 360 degree video ad on an internet web browser of a mobile device, or laptop or desktop computer, or a combination thereof.

The web browser may be an HTML5 compatible web browser, a browser with an embedded media player, or a plugin capable of displaying the 360 degree video ad. The 360 degree video ad may be distributed via common web protocols and languages including hypertext markup language (HTML). In some embodiments, an HTML output associated JavaScript renderer operates as a generic web component that can be used outside an ad application (for example, embedded as a 360 degree video on a website).

In one embodiment, as the user moves a cursor or other interaction point on the screen, the 360 degree video ad pans in that direction. For example, if the user moves the cursor or interaction point to the right, then the view of the 360 degree video ad pans to the right. Likewise, the same occurs for moving the cursor or interaction point to the left, up, or down.

At step 725C, the system interactively displays the 360 degree video ad on a virtual reality engine, virtual reality room, virtual reality application, virtual reality marketplace, virtual reality in-game, or a combination thereof.

The 360 degree video ad may be a full screen 360 degree video ad displayed within the VR environment or a VR billboard advertisement that is attached to a surface within the VR environment without taking up a significant portion of the screen. When the 360 degree video ad is a VR billboard, the user may interact with the 360 degree video ad in a similar manner to that of the interaction with a 360 degree video ad displayed on a web browser as is described previously. When the ad banner is a full screen 360 degree video ad displayed in the VR environment, the ad banner may be interacted with in a manner similar to that of the interaction with a full screen 360 degree video ad displayed on a mobile application as is described previously.

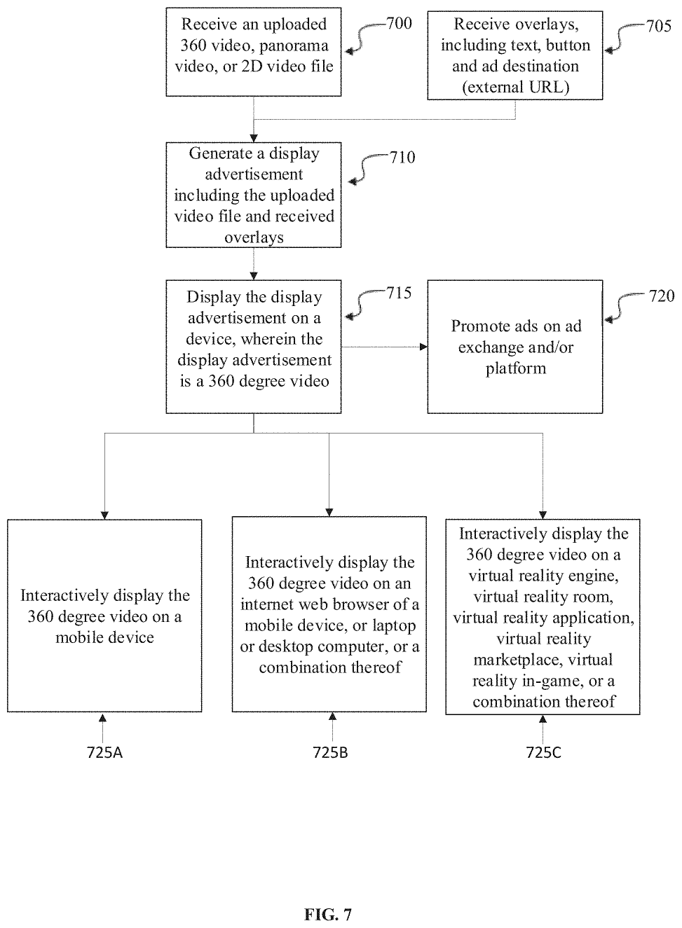

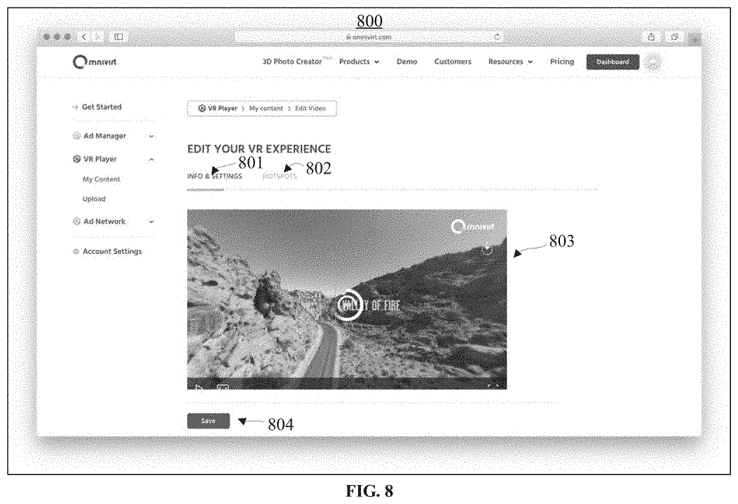

FIG. 8 shows an example of a VR experience editor 800 in accordance with aspects of the present disclosure. VR experience editor may include an info and settings tab 801, hotspots tab 802, VR experience preview 803, and a save button 804. Save button 804 and save button 910 may be the same or different buttons.

VR experience editor 800 may allow user to edit, modify or customize VR environments and experiences. A user may select info and settings tab 801 to edit properties associated with the VR experience or content within the VR experience. The user may upload new content, such as 360 degree images and videos. The user may be prompted with an interface that allows them to click and drag or browse through the file system when selecting content to upload.

VR experience preview 803 may be generated when content is selected or uploaded by the user. The generation of the VR experience preview 803 may provide the user with an indication that content was loaded successfully and that the content is ready.

Other information and settings may be added or modified. Photo and Video information may include title and description, and the user may be able to add a clickable label that will launch a URL or another 360 VR experience. The user may modify or edit the format of the VR experience. The user may be allowed to select a content type, such as content type (e.g. 360 equirectangular, 360 stereo equirectangular, 180 side by side 3D, or panorama). Options for setting or modifying playback quality, continuous rotation properties (speed or turn it off), other effects and properties of the effects. Privacy settings of the VR experience and its content may also be modified by the user.

From the VR experience editor 800, the user may navigate to a hotspot editing interface 900, by selecting the hotspots tab 802.

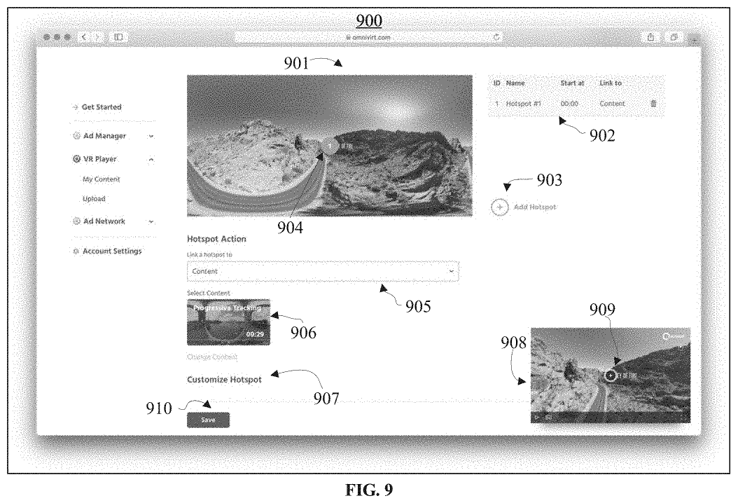

FIG. 9 shows an example of a hotspot editing interface 900 in accordance with aspects of the present disclosure. Hotspot editing interface 900 may include a representative image frame 901, hotspot list 902, add hotspot button 903, hotspot placement indicator 904, link to menu 905, select content icon 906, customize hotspot button 907, environment preview 908, hotspot indicator 909 and a save button 910.

To add hotspots to a VR/AR environment, 360 degree video or 360 degree photo the user may select the add hotspot button 903. Upon selection of the add hotspot button 903, a hotspot placement indicator 904 may be displayed at a default location on the representative image frame 901. They user may then drag and drop the hotspot placement indicator 904 at the desired location or select the location in which the user would like to place the hotspot. Upon placement of the hotspot placement indicator 904, an environment preview 908 may be generated with hotspot indicator 909 overlaid. The hotspot indicator 909 may be animated in response to user interaction, user input, or lack of input. The animation may be that of a ripple, spinning, pulsating, rotating, flashing, changing colors or shapes, or any type of animation that may draw the user's attention to it. Upon completion of adding hotspots to the VR environment, a user may select a save button 910 to save the modifications made. The VR environment may be saved to the client device 100, or any other server, data store, exchange or platform that the user has access to.

Link to menu 905 may list types of linking actions that may be performed by hotspots after they are selected in the VR environment. The user may select options to link a hotspot to content, presentation card, redirect to URL, execute JavaScript, Open VR Menu or other actions that may be provided for the user. Custom actions may also be created by the user or by submitting requests for added functionality from the platform administrators.

If a link to content is selected, the user may be asked to select the content by clicking on the select content icon 906. The user may either select previously uploaded or generated content, or choose to upload new content. Properties of the content may be modifiable, such as content type, playback quality and continuous rotation.

A preview or thumbnail representation of the content selected may be displayed at select content icon 906 after the selection. The content may have a user designated label overlaid on the content along with a preview of the content.

The user may continue adding hotspots for each part of the VR environment that they wish to be explorable (virtual tour). Hotspot list 902 may show a list of the hotspots that have already been added, along with information regarding the hotspot. Each hotspot in the hotspot list 902 may individually be removed or edited.

When adding a presentation card hotspot, the user may add a title and description to the presentation card, as well as select an image to use as the background of the presentation card. A call to action function may be embedded into the presentation card, which may include the options to launch content or redirect to a URL.

A customize hotspot button 907 may allow for a user to edit or customize a newly added hotspot or a previously added hotspot. The selected hotspot may be indicated in the hotspot list 902 by highlighting or visually differentiating the currently selected hotspot from the non-selected hotspots present in the hotspot list 902. Upon selection of customize hotspot button, an interface may be presented to the user that allows for the modifying which content is linked to a hotspot, the properties of the content linked to the hotspot, annotations or other information related to the hotspot, presentation cards linked to the hotspot, or other types of media.

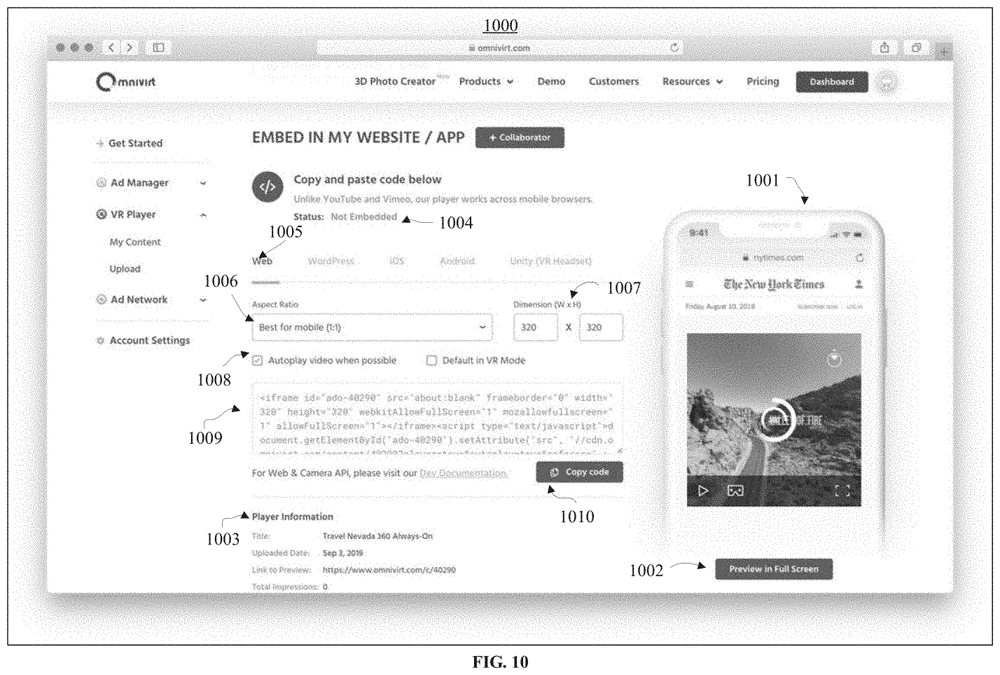

FIG. 10 shows an example of a format conversion interface 1000 in accordance with aspects of the present disclosure. Format conversion interface 1000 may include VR preview pane 1001, preview in full screen button 1002, player information 1003, embedding status 1004, format selector tab 1005, aspect ratio 1006, dimension 1007, play mode 1008, embed code 1009 and copy code button 1010.

Format conversion interface 1000 may allow a user to select a format that the VR content is going to be displayed in, edit properties of the embedding and launch a preview of the VR content. VR preview pane 1001 may display a preview of the content as an embedded video in the selected format. Preview in full screen button 1002 may enlarge the VR preview pane 1001 to a full screen preview.

Player information 1003 may provide the user with information regarding the title of the VR experience, upload date, link to a preview, and the total impressions the VR experience has received. Embedding status 1004 may show if the VR environment is currently embedded in a particular format and platform or exchange. The user may set an aspect ratio 1006, dimension 1007 and play mode for the embedding. The embedding code may be generated and displayed in the embed code 1009 pane. A user may highlight and copy the code manually, or select the copy code button 1010.

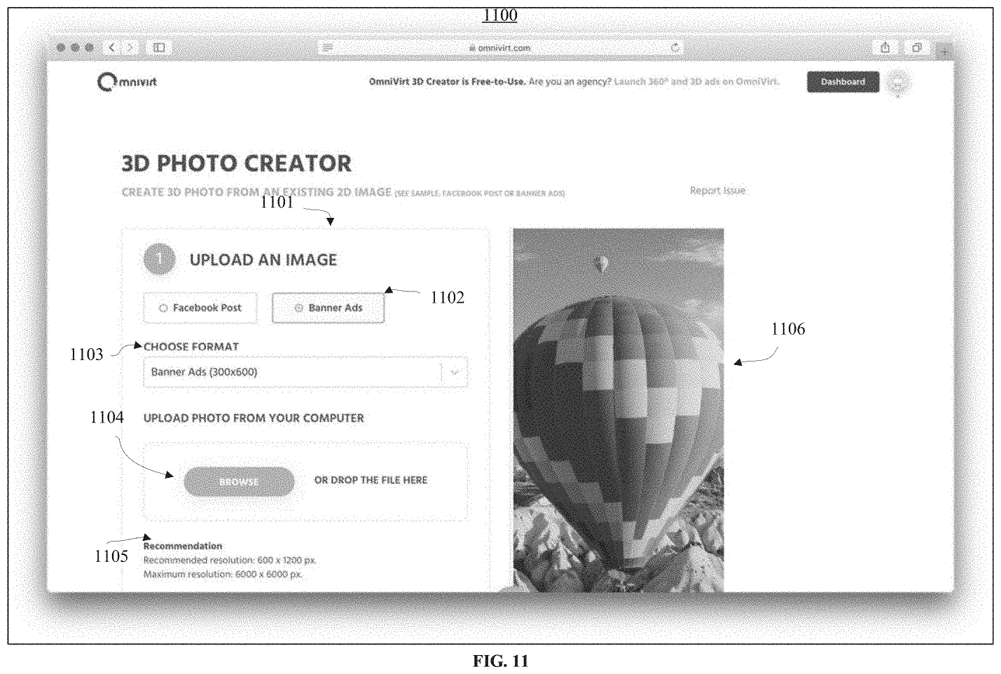

FIG. 11 shows an example of a 3D image creator interface 1100 in accordance with aspects of the present disclosure. 3D image creator interface 1100 may include upload image frame 1101, 3D image type selector 1102, 3D image format selector 1103, file upload 1104, format recommendation 1105 and 3D image preview pane 1106. The 3D photo image can be generated from an uploaded two dimensional image.

Image type selector 1102 may provide the user with options for creation of the 3D image. Options may include but are not limited to, ad banners, social media posts, and other destinations and/or platforms that support interactive 3D images. Image format selector 1103 may provide different resolution options for different selected image types.

File upload 1104 may receive a two dimensional (2D) image file and a depth map. In some cases, the depth map comprises a 2D depth image including a set of pixels, each pixel representing a depth value for a corresponding pixel of the 2D image file. File upload 1104 may receive the depth map as a separately uploaded file from a user or a depth map embedded or combined with the 2D image file.

File upload 1104 may receive the 2D image file as an uploaded file from a user. File upload 1104 may also receive the depth map as an uploaded file from the user. The depth map may be generated by a 3D image rendering system, selected and uploaded by the image type selector 1102, or can be embedded in the 2D image file.

Upon uploading of the 2D image file and optionally the 2D depth image, the system may construct a 3D mesh from the depth map. In some cases, the 3D mesh comprises a 3D representation of the depth map and includes a set of vertices, edges, and faces. A mapping process on the system may map the 2D image file as a texture on the 3D mesh to create a 3D image.

An interpolation process may interpolate a set of missing pixel values in the texture from other pixel values in the texture, such as adjacent pixel values. The system may then render the 3D image in the 3D image preview pane 1106.

When a depth map is not uploaded with the 2D image file, the system may generate, by a machine learning depth prediction model, the depth map from the 2D image file. The machine learning depth prediction model may be trained on a dataset of images and corresponding depth maps.

In other examples, the depth map is generated simultaneously with the 2D image file by a camera with a depth sensing system. The depth sensing system may comprise, for example, an infra-red sensor, sonar, or other sensors. The depth sensing data captured by the sensor may be used to generate a depth map that is stored in the same file as the 2D image file, in some cases as EXIF data.

In some embodiments, the 2D image file may be uploaded from a client device 100, and the depth map may be either uploaded or generated based on the 2D image file.

In cases where a depth map is not provided with the 2D image file, a depth prediction model may be used to generate a depth map. The depth prediction model may comprise a neural network (NN). A NN may be a hardware or a software component that includes a number of connected nodes (a.k.a., artificial neurons), which may be seen as loosely corresponding to the neurons in a human brain. Each connection, or edge, may transmit a signal from one node to another (like the physical synapses in a brain). When a node receives a signal, it can process the signal and then transmit the processed signal to other connected nodes. In some cases, the signals between nodes comprise real numbers, and the output of each node may be computed by a function of the sum of its inputs. Each node and edge may be associated with one or more node weights that determine how the signal is processed and transmitted.

During the training process, these weights may be adjusted to improve the accuracy of the result (i.e., by minimizing a loss function which corresponds in some way to the difference between the current result and the target result). The weight of an edge may increase or decrease the strength of the signal transmitted between nodes. In some cases, nodes may have a threshold below which a signal is not transmitted at all. The nodes may also be aggregated into layers. Different layers may perform different transformations on their inputs. The initial layer may be known as the input layer and the last layer may be known as the output layer. In some cases, signals may traverse certain layers multiple times. In one example, the training set may include a large number of images as input and a corresponding set of depth maps as the target output.

In some embodiments, the 2D image file may be processed by a person detector to determine whether a person is present in the 2D photo image. The 2D image file may be analyzed by an artificial neural network, or other machine learning model, to determine the presence of a person or not. The system may then detect the position of a face of the person and create a cropped image of the face of the person. A neural network or other machine learning model may be used to classify and extract position information of a face region of the person in the 2D image file. This information may then be used to crop the pixels which make up the face region. The cropped image of the face of the person may be input to a face depth map generator to create a face depth map. The cropped image of the persons face along with the extracted position information of the face region may be used to reconstruct volumetric information of the face. This information may be converted or mapped to a 3D mesh model of a human face. An artificial neural network or other machine learning model may be used to estimate depth of pixels in the cropped image, allowing for the construction of a 3D mesh that is mapped to respective points on the cropped image. This 3D mesh is used to convert the volumetric information into a grayscale depth map of a human face.

The first 2D image file may be segmented into person and background segments. The 2D image file may be analyzed by an artificial neural network or other machine learning model to classify and segment different portions of the image. The artificial neural network may be trained and optimized for the detection of people and backgrounds. An edge detection process (e.g., Hough transform) may also be used to aid in the segmentation of foreground objects, like a person, from the background. Higher depth values may be assigned to the pixels in the person segment than the pixels in the background segment to create a scene depth map.

The face depth map and scene depth map may be combined to create a combined depth map of the 2D image file. The face depth map and scene depth map may be blended together and post-processed to generate the final depth map.

In some embodiments, the 2D image file may be analyzed by an artificial neural network, or other machine learning model, and determine that the is no person present in the image. The 2D image file may be processed by a scene depth map generator to create a depth map of the 2D image file. The scene depth map generator may use an artificial neural network, or other machine learning model, specifically trained and optimized for landscape and other common objects and scenes, to estimate the depths of pixels in the 2D image file. These estimations may be used to generate a rough scene depth map that may then be post-processed to generate a final scene depth map.

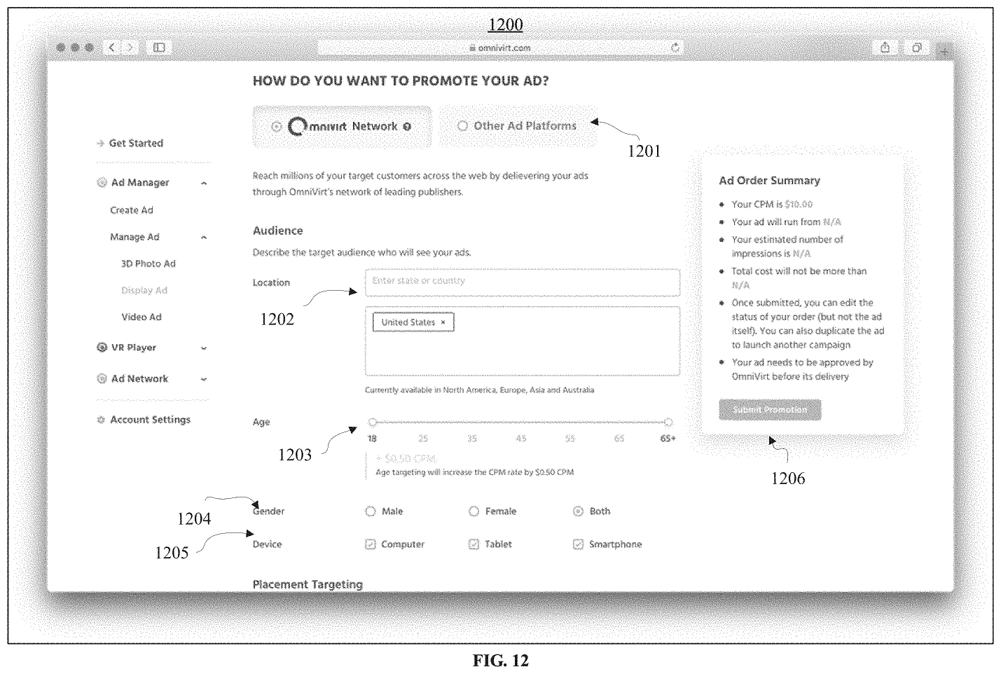

FIG. 12 shows an example of an ad promotion interface 1200 in accordance with aspects of the present disclosure. Ad promotion interface 1200 may include an ad platforms tab 1201, location selection 1202, age selection 1203, gender selection 1204, device selection 1205 and submit promotion button 1206.

Ad promotion interface 1200 may allow a user to promote and distribute an ad campaign. Ad platforms and exchanges may be selected from the ad platform tab 1201. When promoting an ad campaign, the user may select a location from location selection 1202. Location selection 1202 may provide a user with a populated list of locations from which a user may choose. The user may be allowed to select one or more locations. A text search for locations may be performed by the user. When entering text, the field may perform an autocomplete recommendation. The user may select one or more locations from the list of locations that match the search string. The user may select multiple locations from the list without having to type a new search string. The user may type additional search strings to find additional locations to select. The interface may display a list of selected locations. Each location may be individually removable. The user may be given the option to reset and remove all locations to start again. The list of locations may be ordered alphabetically or ranked by importance. Different locations may be of higher importance than others and promoted more in those areas. The budget may be split evenly amongst all locations, or split based on importance or other criteria of the locations. Locations may be grouped by percentage of budget that they will receive, or by their importance rank.

Age selection 1203 may allow for the user to select the target demographics age from a menu, entered through text by a user, or through the use of a slider to indicate an age range. The ranges need not be continuous, and there may be age ranges excluded from the promotion of the ad campaign. Multiple separate ranges may be selected.

Gender selection 1204 may allow a user to select any number of genders. Gender may be a non-binary selection. Any combination of gender identities may be selectable by the user.

Device selection 1205 may allow a user to select what type of device the ad campaign will be promoted on.

The user may be presents with options for placement targeting. A list of categories may be selectable by the user. Categories may include news & magazines, fashion & style, travel, teen, women's, men's, music, entertainment, business and home & living. The user may select one or more categories. The selection of a category may automatically populate a list with domain names of web sites that the ads will be run on. The user may add more domains to the list by entering the domain names or manually selecting from displayed list of additional domain names.

The user may set a budget and schedule for the ad campaign as well as a cost per 1000 impressions (CPM). The selection of an ad campaign schedule may be accomplished through entering text, a menu selection, or selecting the start and end dates on a calendar.

The user may set a budget type, such as a daily budget or lifetime budget. Entering a daily budget may automatically calculate a total budget for the entire campaign.

A summary of the campaign details such as your CPM, dates the campaign will be run, your estimated number of impressions, and your total cost, may be displayed before the user selects the submit promotion button 1206.

Upon submission, an ad campaign may require approval from the exchange or platform before the ad campaign may be launched. Once submitted, the user may check the status of the approval. After the ad campaign is launched, the user may pause the campaign or turn the campaign back on. The user may also duplicate the ad and launch another campaign with different targeting criteria.

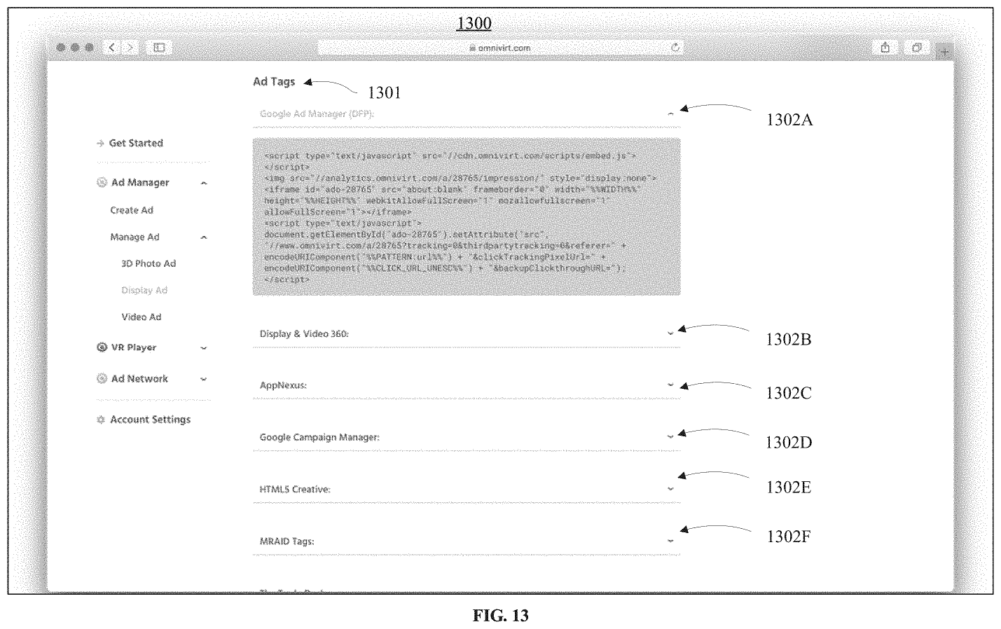

FIG. 13 shows an example of an ad tags interface 1300 in accordance with aspects of the present disclosure. Ad tags interface 1300 may include an ad tags heading 1301, and ad tags 1302A-1302F for individual exchanges and platforms. The ad tags 1302A-1302F may be selected and copied. Once copied, the user may embed the ad tags into the desired exchange or platform.

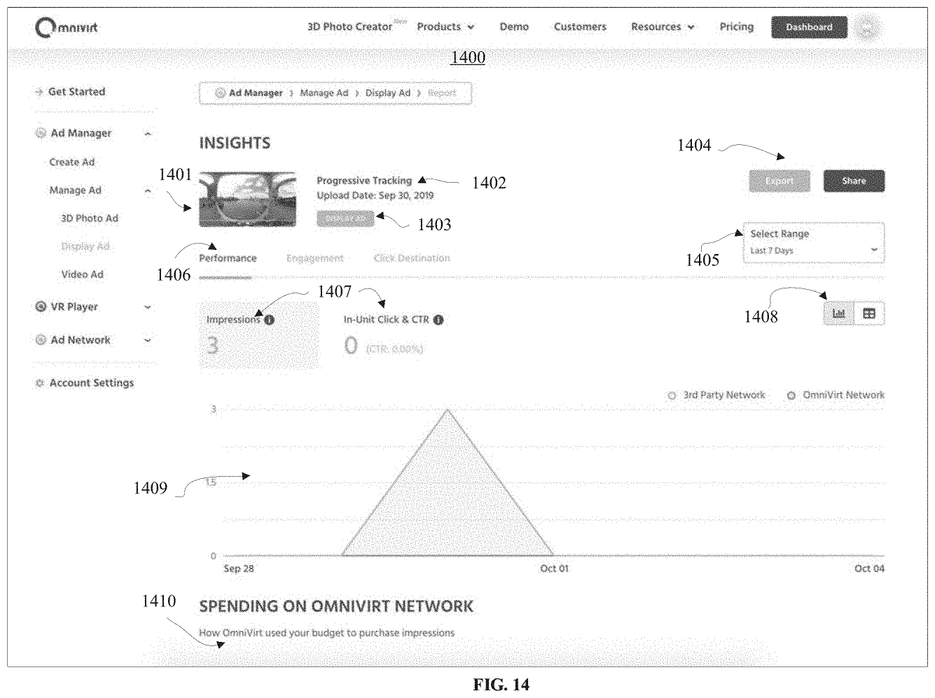

FIG. 14 shows an example of an ad insights interface 1400 in accordance with aspects of the present disclosure. Ad insights interface 1400 may include an ad thumbnail 1401, progress tracker 1402, display ad button 1403, export selection 1404, date range 1405, analysis selection 1406, analysis statistics 1407, data format 1408, data visualization 1409 and spending report 1410

The progress tracker 1402 may show the upload date, and other information related to the status and duration of the ad campaign. The display ad button 1403 may be selected to launch a preview version of the ad campaign for the user to see. The export selection may be used to export or share the generated analysis results. The user may choose a date range 1405, from which to export the analysis results. An analysis selection 1406 may be provided for a user to select and subsequently view performance of the ads and other insights into the effectiveness of the ad campaign. The user may choose from one or more statistical analysis of the ad campaign. Analysis statistics 1407 can be generated for display to the user. User can generate a custom analysis of the data collected on the ad campaign. Impression, user data, time of impressions and engagement may all be tracked and analyzed. Custom formulas may be used in the generating of a new analysis. Default categories of analysis may be displayed, such as performance metrics, engagement metrics, and click destinations. There may be different performance data for multiple networks, and the interface may graph

A user may select a data format 1408 to change the way information is displayed by data visualization 1409. Data visualization 1409 may graph individual performance of individual networks, all networks in a single graph/chart or other data visualization, a user selectable group of networks, or groups of networks that are classified as being similar based off of similar performances. For example, the system may automatically show separate graphs for the highest performing group networks and the lowest performing group of networks. The graphs may be displayed simultaneously or one at a time. A user may also specify the properties of a custom group that will then generate graphs only representing those networks that meet the requirements of the user specified property.

A spending report 1410 may be generated for the user. The spending report may be an overall spending report for the ad campaign, or a spending report for a selected exchange or platform.

Ad insights interface 1400 may also provide the user with real-time advertisement performance analytics. Analytics relating to a specific user, ad campaign, ad platform or exchange, multiple ad campaigns run by a single entity or user, or a combination thereof, may be generated by gathering information in real-time and performing statistical analysis or other forms of analysis on the information in real time. Data visualization techniques may be used to display the real-time and/or streaming data being produced from the analysis. The visualization may be updated in real-time, as the data is received. The visualization may also show a moving average of data that is updated in real-time. information to the user of the interface.

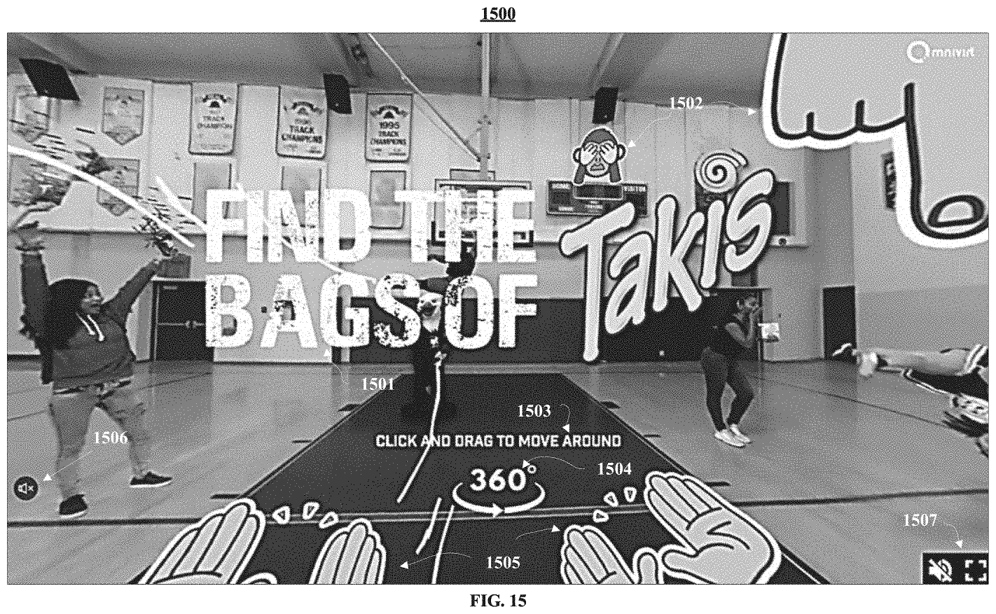

FIG. 15 shows an example of a VR game experience 1500 in accordance with aspects of the present disclosure. VR game experience 1500 may include 2D text overlay 1501, 2D image overlays 1502, interaction instruction text 1503, interaction instruction symbol 1504 (e.g. 360 and arrow) and 1505 (e.g. pressing hands), volume mute 1506, and mode selection 1507.

VR game experience 1500 may be interacted with in a similar fashion to the previously discussed 360 degree video ads, 360 degree banner ads, and VR experiences.

FIG. 15 may alternatively show an example of an augmented reality (AR) game experience 1500 in accordance with aspects of the present disclosure. AR game experience 1500 may include 2D text overlay 1501, 2D image overlays 1502, interaction instruction text 1503, interaction instruction symbol 1504 (e.g. 360 and arrow) and 1505 (e.g. pressing hands), volume mute 1506, and mode selection 1507.

AR game experience 1500 may be interacted with in a similar fashion to the previously discussed 360 degree video ads, 360 degree banner ads, and VR experiences.

AR game experience 1500 disclosed, may allow a user to move around and navigate within an AR environment, interact with points of interest, hotspots and objects, and view annotations or information related to objects or points of interest that are being focused on or selected. Selected objects or points of interest may link to 2D videos, slideshow, 360 degree photos or videos, a 360 degree VR experience or another AR environment. The AR environment may allow for a user to manipulate the position, orientation or other properties and parameters of an object, hotspot or point of interest. Points of interest and hotspots may be added and annotated by the user while operating within the AR environment. The viewing angle of the environment and/or objects within the environment may be manipulated through gestures or based upon output from gyroscope 221 and/or accelerometer 222.

The AR game experience 1500 is generated on a display, and may include a process that map the environment, generate a 3D model of the environment, and orient the client device 100 with the environment. Real-time photo images may be captured from one or more cameras. The images may be 2D, 2.5D, or 3D images. These captured images may then be used to update the 3D model of the environment or to composite the AR images. Interactive 3D objects may be overlayed on the real-time photo images. The interactive 3D objects may be positioned, scaled/sized and orientated with relation to the 3D model of the environment prior to being rendered. The system may then composite and overlay the interactive 3D image onto the captured images/videos.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

In general, the terms “engine” and “module”, as used herein, refer to logic embodied in hardware or firmware, or to a collection of software instructions, possibly having entry and exit points, written in a programming language, such as, for example, Java, JavaScript, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on one or more computer readable media, such as a compact discs, digital video discs, flash drives, or any other tangible media. Such software code may be stored, partially or fully, on a memory device of the executing computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. Generally, the modules described herein refer to logical modules that may be combined with other modules or divided into sub-modules despite their physical organization or storage

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method for distributing a three dimensional (3D) online advertisement, the method comprising:
receiving an uploaded 3D image file, the 3D image file comprising a panoramic photo or panoramic video;
converting the 3D image file to a first format configured to be accepted by a first digital advertising platform;
generating a display advertisement including the 3D image file;
displaying the display advertisement on a device through the first digital advertising platform.

2. The computer-implemented method of claim 1, wherein the 3D image file further comprises a 360 degree 3D photo, 360 degree 3D video, 360 degree stereo photo, 360 degree stereo video, or a combination thereof.

3. The computer-implemented method of claim 1, wherein the panoramic photo is a 360 degree photo, 360 degree 3D photo, or 360 degree stereo photo, and the panoramic video is a 360 degree video, 360 degree 3D video, or 360 degree stereo video.

4. The computer-implemented method of claim 1, wherein the digital advertising platform can be supported by an internet browser webpage, a mobile application running on a mobile device operating system, a desktop application running on a desktop operating system, a gaming or game engine, a virtual reality engine, or a combination thereof.

5. The computer-implemented method of claim 1, wherein the display advertisement is an ad banner comprising the 3D image file, one or more lines of text, one or more logos, one or more two dimensional (2D) images, one or more 2D graphics, one or more 2D animations, a background image, or a combination thereof.

6. The computer-implemented method of claim 5, wherein the ad banner comprises an interactive 3D photo image configured for engagement with a user when the user is viewing, interacting, or both, with the ad banner.

7. The computer-implemented method of claim 1, wherein the display advertisement is a 360 degree video comprising the 3D image file.

8. The computer-implemented method of claim 7, wherein the 360 degree video comprises an interactive 3D photo image configured for engagement with a user when the user is viewing, interacting, or both, with the 360 degree video.

9. The computer-implemented method of claim 5, wherein the ad banner can be interactively displayed on a mobile application of a mobile device.

10. The computer-implemented method of claim 5, wherein the ad banner can be interactively displayed on an internet web browser of a mobile device, or laptop or desktop computer, or a combination thereof.

11. The computer-implemented method of claim 5, wherein the ad banner can be interactively displayed on a virtual reality engine, virtual reality room, virtual reality application, virtual reality marketplace, virtual reality in-game, or a combination thereof.

12. The computer-implemented method of claim 5, wherein the ad banner is displayed on a portion of the visual display in the virtual reality application.

13. The computer-implemented method of claim 7, wherein the 360 degree video can be interactively displayed on a mobile application of a mobile device.

14. The computer-implemented method of claim 7, wherein the 360 degree video can be interactively displayed on an internet web browser of a mobile device, or laptop or desktop computer, or a combination thereof.

15. The computer-implemented method of claim 7, wherein the 360 degree video can be interactively displayed on a virtual reality engine, virtual reality room, virtual reality application, virtual reality marketplace, virtual reality in-game, or a combination thereof.

16. The computer-implemented method of claim 1 above, further comprising, generating a 3D photo image from an uploaded two dimensional (2D) image file, the two dimensional (2D) image file having a depth map either generated by 3D image rending system or embedded in the 2D image file.

17. The computer-implemented method of claim 1 above, wherein generating the display advertisement can be dependent upon receiving instructions for targeting preference determined by selection of types of electronic devices used, age of user, gender of user, location of user, average duration of engagement detected of the user, budget of an advertising campaign, type of web site or web page, or a combination thereof.

18. The computer-implemented method of claim 1, further comprising generating advertisement performance analytics in real time about a specific user, an advertisement campaign, or a combination thereof.
